(19) United States
(12) Patent Application Publication
(10) Pub. No.: US 2024/0073411 A1
(43) Pub. Date: Feb. 29, 2024

(54) Weighted image prediction, image coding and decoding using such a weighted prediction

(71) Applicant: ORANGE, Issy-les-Moulineaux (FR)

(72) Inventors: Pierrick Philippe, CHATILLON CEDEX (FR); Théo Ladune, CHATILLON CEDEX (FR)

(21) Appl. No.: 18/546,854

(22) PCT Filed: Feb. 15, 2022
(86) PCT No.: PCT/FR2022/050272

§ 371 Date: Aug. 17, 2023

(30) Foreign Application Priority Data
Feb. 19, 2021 (FR) FR2101632

(51) Int. Cl. H04N 19/105; H04N 19/137; H04N 19/182; H04N 19/436; H04N 19/463; H04N 19/577

(52) U.S. Cl. CPC H04N 19/105; H04N 19/137; H04N 19/182; H04N 19/436; H04N 19/463; H04N 19/577

(57) ABSTRACT

A method for predicting at least one set of current pixels, implemented by a prediction device, in which at least one set of current pixels is predicted on the basis of at least one set of reference pixels, with the assistance of a pixel prediction weighting function. The pixel prediction weighting function of the at least one set of current pixels is associated with at least one weighting value calculated on the basis of an analysis of at least one set of reference pixels.

### FIELD OF THE INVENTION

The present invention relates in general to the field of image processing, and more specifically to the coding and the decoding of digital images and of sequences of digital images.

The coding/decoding of digital images applies in particular to images from at least one video sequence comprising:
images from one and the same camera and in temporal succession (2D coding/decoding),
images from various cameras oriented with different views (3D coding/decoding),
corresponding texture and depth components (3D coding/decoding),
etc.

The present invention applies similarly to the coding/decoding of 2D or 3D images. The invention may in particular, but not exclusively, be applied to the video coding implemented in current AVC, HEVC and VVC video encoders and their extensions (MVC, 3D-AVC, MV-HEVC, 3D-HEVC, etc.), and to the corresponding decoding.

### PRIOR ART

Current video encoders (MPEG, AVC, HEVC, VVC, AV1, etc.) use a blockwise representation of the video sequence. The images are split up into blocks, which are able to be split up again recursively. Next, each block is coded by intra-image or inter-image prediction. Thus, some images are coded by spatial prediction (intra prediction, IBC (for “Intra Block Copy”) prediction), and other images are also coded by temporal prediction (inter prediction) with respect to one or more coded-decoded reference images, using motion compensation, which is well known to those skilled in the art.

A prediction block BP associated with a block currently being coded is related directly to at least one reference block BR₀ of the image to which the block currently being coded belongs or of an already decoded image, conventionally called reference image. In order to match the reference block BR₀ to the block currently being coded, the reference block BR₀ is displaced for each spatial position (x,y) of the pixels thereof. A motion-compensated reference block BC₀ is then obtained. The relationship between the prediction block BP and the motion-compensated reference block BC₀ is then expressed as follows:

BP(x,y)=(1−w)*BC₀(x,y)

where w is a prediction weighting parameter, which is 0 most of the time, but which may be adjustable, as explained below.

When for example a block currently being coded is predicted with respect to two reference blocks BR₀ and BR₁ belonging to one or two already decoded reference images, the two reference blocks BR₀ and BR₁ are motion-compensated, generating two motion-compensated reference blocks BC₀ and BC₁, which are then combined by linear weighting. Each pixel of the prediction block BP is the result of weighting of the pixels of the two motion-compensated reference blocks BC₀ and BC₁. More precisely, if for example the prediction is implemented row by row, and from left to right:
the 1^{st} pixel at the top left of the prediction block BP is the result of weighting of the 1^{st} pixel at the top left of the motion-compensated reference block BC₀ and of the 1^{st} pixel at the top left of the motion-compensated reference block BC₁,
the 2^{nd} pixel, neighboring the 1^{st} pixel on the first row of the prediction block BP, is the result of weighting of the 2^{nd} pixel neighboring the 1^{st} pixel on the first row of the motion-compensated reference block BC₀ and of the 2^{nd} pixel neighboring the 1^{st} pixel on the first row of the motion-compensated reference block BC₁,
etc.,
the last pixel at the bottom right of the prediction block BP is the result of weighting of the last pixel at the bottom right of the motion-compensated reference block BC₀ and of the last pixel at the bottom right of the motion-compensated reference block BC₁.

The most common weighting, applied by default, is the half-sum. To this end, the prediction block BP is computed according to the following relationship:

BP(x,y)=0.5*BC₀(x,y)+0.5*BC₁(x,y)

More elaborate weightings are possible.

In the HEVC standard, the linear weighting is applied uniformly to the image currently being coded. The weighting parameter w is fixed therein, and is signaled to the decoder, for each sub-image or “slice” of the image currently being coded. By default, in the case of a bi-prediction of the block currently being coded, the balanced weighting (0.5/0.5) is applied unless this is explicitly indicated in the PPS (for “Picture Parameter Set”) information.

In the VVC standard, the prediction is weighted block by block using the BCW (for “bi-prediction with CU level weights”) tool. A prediction block BP is computed according to the following relationship:

BP(x,y)=(1−w)*BC₀(x,y)+w*BC₁(x,y)

where the weighting parameter w may take 5 values: 0.5, 0.625, 0.375, 1.25, −0.25. The optimum value of the weighting parameter w to be applied is determined at the encoder and signaled to the decoder for each block. It is encoded with a context element that indicates whether it is the value w=0.5 that is used, that is to say the equal weighting on the motion-compensated reference blocks BC₀ and BC₁. If not, then the weighting is signaled on 2 bits to indicate one of the 4 remaining values. This principle is adopted in the AV1 technique.

It should be noted that, regardless of the video standard used, the weighting parameter w is associated with a relatively small number of values, thereby leading to a lack of precision in the weighted prediction that is applied. Furthermore, the encoder according to the abovementioned standards systematically has to code and transmit, to the decoder, the value of the weighting parameter w that has been selected, thereby increasing the signaling cost.

### AIM AND SUMMARY OF THE INVENTION

One of the aims of the invention is to rectify the drawbacks of the abovementioned prior art by improving the precision of the weighted prediction from the prior art, in favor of reducing the cost of signaling information related to this prediction.

To this end, one subject of the present invention relates to a method for predicting at least one current set of pixels, implemented by a prediction device, wherein said at least one current set of pixels is predicted based on at least one reference set of pixels, using a pixel prediction weighting function, characterized in that the pixel prediction weighting function for said at least one current set of pixels is associated with at least one weighting value computed based on analysis of at least one reference set of pixels.

Such a prediction method according to the invention advantageously makes it possible to rely only on one or more reference sets of pixels, in other words one or more sets of pixels that are already decoded at the time of the prediction, to estimate the weighting of the prediction of a current set of pixels. Since this or these reference sets of pixels are available at the time of the prediction of the current set of pixels, the estimation of the weighting of the prediction is improved as it is more spatially precise than that implemented in the prior art, which requires approximating or quantizing the one or more weighting values of the prediction.

According to one particular embodiment, the prediction weighting function is modified using at least one modification parameter that results from analysis of said at least one current set of pixels.

Such an embodiment advantageously makes it possible to apply a correction to the prediction weighting function that has been computed, when the current set of pixels contains an element that was not present/predictable in the one or more reference sets of pixels.

The invention also relates to a device for predicting at least one current set of pixels, comprising a processor that is configured to predict said at least one current set of pixels based on at least one reference set of pixels, using a pixel prediction weighting function.

Such a prediction device is characterized in that the pixel prediction weighting function for said at least one current set of pixels is associated with at least one weighting value computed based on analysis of at least one reference set of pixels. In one particular embodiment, the prediction device is a neural network.

The use of a neural network advantageously makes it possible to optimize the quality of the weighted prediction.

Such a prediction device is in particular able to implement the abovementioned prediction method.

The invention also relates to a method for coding at least one current set of pixels, implemented by a coding device, comprising the following:
computing a signal representative of a difference between said at least one current set of pixels and a prediction set of pixels resulting from a prediction of said at least one current set of pixels,
coding the signal.

Such a coding method is characterized in that the prediction set of pixels is obtained using the abovementioned prediction method according to the invention.

Such a coding method is advantageous in that it does not require the coding of one or more prediction weighting values of the prediction weighting function. This means that this or these prediction weighting values do not need to be transmitted by the encoder to a decoder for the current set of pixels, thereby making it possible to reduce the cost of signaling the information transmitted between the encoder and the decoder in favor of better quality of the image related to the improved precision of the prediction. Furthermore, any weighting value associated with the prediction weighting function does not need to be approximated or quantized with a view to being transmitted to the decoder, thereby making it possible to make this weighting value continuous for the set of pixels to be predicted.

According to one particular embodiment, the coding method comprises the following:
coding at least one modification parameter of the prediction weighting function,
transmitting said at least one modification parameter to an image decoder.

The invention also relates to a coding device or encoder for coding at least one current set of pixels, comprising a processor that is configured to implement the following:
computing a signal representative of a difference between said at least one current set of pixels and a prediction set of pixels resulting from a prediction of said at least one current set of pixels,
coding said signal.

Such a coding device is characterized in that the prediction set of pixels is obtained using the abovementioned prediction device according to the invention.

Such a coding device is in particular able to implement the abovementioned coding method.

The invention also relates to a method for decoding at least one current set of pixels, implemented by a decoding device, comprising the following:
determining, in a data signal, data representative of a signal representative of a difference between said at least one current set of pixels and a prediction set of pixels resulting from a prediction of said at least one current set of pixels,
reconstructing said at least one current set of pixels from the determined data and from the prediction set of pixels.

Such a decoding method is characterized in that the prediction set of pixels is obtained using the abovementioned prediction method according to the invention. The advantage of such a decoding method lies in the fact that the prediction weighting function is computed autonomously by the decoder based on one or more available reference sets of pixels, without the decoder needing to read specific information from the data signal received from the encoder. Moreover, as already explained above, the at least one weighting value of the prediction weighting function, since it is neither coded nor transmitted in a data signal, may be made continuous, without having to be approximated or quantized, as is the case in the prior art.

In one particular embodiment, such a decoding method further comprises the following:
determining, in the data signal or another data signal, at least one modification parameter of the prediction weighting function,
computing a modified prediction weighting function based on the analysis of said at least one reference set of pixels and said at least one determined modification parameter.

The invention also relates to a decoding device or decoder for decoding at least one current set of pixels, comprising a processor that is configured to implement the following:
determining, in a data signal, data representative of a signal representative of a difference between said at least one current set of pixels and a prediction set of pixels resulting from a prediction of said at least one current set of pixels,
reconstructing said at least one current set of pixels from the determined data and from the prediction set of pixels.

Such a decoding device is characterized in that the prediction set of pixels is obtained using the abovementioned prediction device according to the invention.

Such a decoding device is in particular able to implement the abovementioned decoding method.

The invention also relates to a method for constructing at least one set of pixels from at least one reference set of pixels, implemented by a video data processing device. Such a construction method is characterized in that the set of pixels is constructed using a pixel prediction weighting function, such as the prediction function used in the abovementioned prediction method of the invention.

The prediction weighting function of the invention is thus not limited just to the context of an image prediction generating or not generating a prediction residual, and may be advantageously used in the case of an interpolation or an image synthesis based on one or more already decoded reference images.

The invention also relates to a computer program comprising instructions for implementing the prediction method according to the invention and also the coding or decoding method integrating the prediction method according to the invention, or else the abovementioned construction method, according to any one of the particular embodiments described above, when said program is executed by a processor. Such instructions may be permanently stored in a non-transitory memory medium of the prediction device implementing the abovementioned prediction method, of the encoder implementing the abovementioned coding method, of the decoder implementing the abovementioned decoding method, of the video processing device implementing the abovementioned construction method.

This program may use any programming language and be in the form of source code, object code or intermediate code between source code and object code, such as in a partially compiled form, or in any other desirable form.

The invention also targets a computer-readable recording medium or information medium comprising instructions of a computer program as mentioned above. The recording medium may be any entity or device capable of storing the program. For example, the medium may comprise a storage means, such as a ROM, for example a CD-ROM, a DVD-ROM, a synthetic DNA (deoxyribonucleic acid), etc., or a microelectronic circuit ROM, or else a magnetic recording means, for example a USB key or a hard disk.

Moreover, the recording medium may be a transmissible medium such as an electrical or optical signal, which may be conveyed via an electrical or optical cable, by radio or by other means. The program according to the invention may in particular be downloaded from a network such as the Internet.

Alternatively, the recording medium may be an integrated circuit in which the program is incorporated, the circuit being designed to execute or to be used in the execution of the abovementioned prediction method, coding method, decoding method or construction method.

### BRIEF DESCRIPTION OF THE DRAWINGS

Other features and advantages will become apparent from reading particular embodiments of the invention, which are given by way of illustrative and non-limiting examples, and the appended drawings, in which:

FIG. 1 shows the main steps of an image prediction method in accordance with the invention,

FIG. 2A shows one type of prediction used in the prediction method of FIG. 1, in a first particular embodiment of the invention,

FIG. 2B shows one type of prediction used in the prediction method of FIG. 1, in a second particular embodiment of the invention,

FIG. 3A shows a prediction device implementing the prediction method of FIG. 1, in a first embodiment,

FIG. 3B shows a prediction device implementing the prediction method of FIG. 1, in a second embodiment,

FIG. 4 shows, in more detail, certain steps of the prediction method implemented by the prediction device of FIG. 3A,

FIG. 5A shows a first exemplary displacement of a predicted version of a current set of pixels with respect to two reference sets of pixels,

FIG. 5B shows a second exemplary displacement of a predicted version of a current set of pixels with respect to two reference sets of pixels,

FIG. 5C shows a third exemplary displacement of a predicted version of a current set of pixels with respect to two reference sets of pixels,

FIG. 5D shows motion compensation implemented in the case of the type of displacement of FIG. 5A, in one particular embodiment of the invention,

FIG. 5E shows a weighted prediction implemented at the end of the motion compensation of FIG. 5D, in one particular embodiment of the invention,

FIG. 5F shows summed weighting implemented at the end of the weighted prediction of FIG. 5E, in one particular embodiment of the invention,

FIG. 5G shows compensated weighting implemented at the end of the summed weighting of FIG. 5F, in one particular embodiment of the invention,

FIG. 5H shows the obtaining of a predicted version of a current set of pixels from the compensated weighting illustrated in FIG. 5G, in one particular embodiment of the invention,

FIG. 6 shows the main steps of an image coding method implementing the prediction method of FIG. 1, in one particular embodiment of the invention,

FIG. 7A shows an encoder implementing the coding method of FIG. 6, in a first embodiment,

FIG. 7B shows an encoder implementing the coding method of FIG. 6, in a second embodiment,

FIG. 8 shows the main steps of an image decoding method implementing the prediction method of FIG. 1, in one particular embodiment of the invention,

FIG. 9A shows a decoder implementing the decoding method of FIG. 8, in a first embodiment,

FIG. 9B shows a decoder implementing the decoding method of FIG. 8, in a second embodiment,

FIG. 10 shows the steps of an image coding method implementing a modification of the prediction method of FIG. 1, in one particular embodiment of the invention,

FIG. 11 shows an encoder implementing the coding method of FIG. 10, in one particular embodiment of the invention,

FIG. 12 shows the steps of an image decoding method implementing a modification of the prediction method of FIG. 1, in one particular embodiment of the invention,

FIG. 13 shows a decoder implementing the decoding method of FIG. 12, in one particular embodiment of the invention,

FIG. 14 shows an encoder implementing the coding method of FIG. 10, in another particular embodiment of the invention,

FIG. 15 shows a decoder implementing the decoding method of FIG. 12, in another particular embodiment of the invention.

### DETAILED DESCRIPTION OF VARIOUS EMBODIMENTS OF THE INVENTION

### Exemplary Implementations of an Image Prediction Method

### General Principle of the Invention

### Image Weighted Prediction Method

A description is given below of a 2D or 3D image prediction method that is able to be implemented in any type of video encoders or decoders, for example compliant with the AVC, HEVC, VVC standard and their extensions (MVC, 3D-AVC, MV-HEVC, 3D-HEVC, etc.), or the like, such as for example a convolutional neural network (or CNN).

With reference to FIG. 1, the prediction method according to the invention uses at least one reference set of pixels BR₀, that is to say a reference set of pixels that has already been coded and decoded and that is therefore available at the time of the prediction. One feature of the prediction method according to the invention is that a current set of pixels B_{c} is not considered for the prediction as it is not available at the time of the prediction.

Within the meaning of the invention, a current set of pixels B_{c} is understood to mean:
an original current image;
a part or a region of the original current image,
a block of the current image resulting from partitioning of this image in line with what is carried out in standardized AVC, HEVC or VVC encoders.

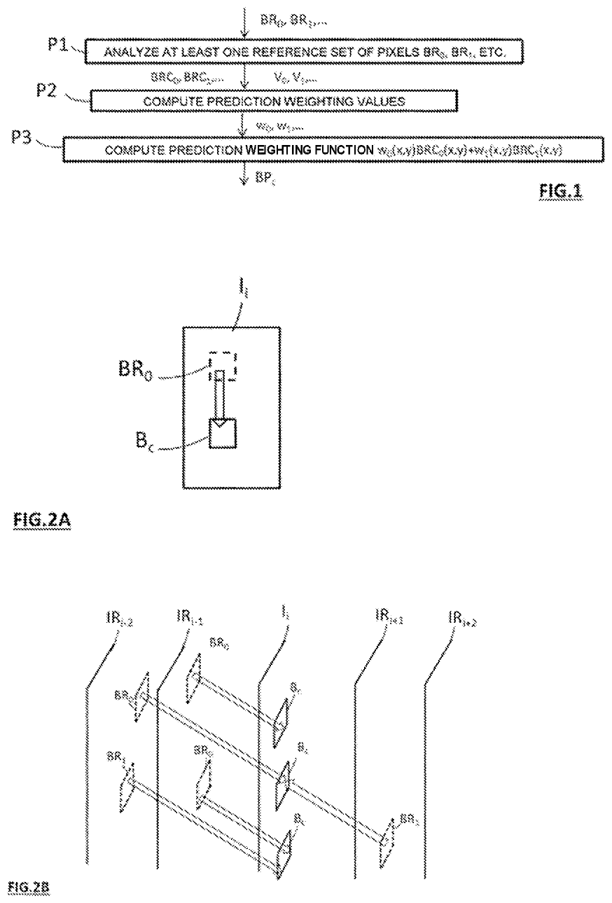

According to the invention, as shown in FIG. 2A, the reference set of pixels BR₀ may belong to a current image Iᵢ that contains the current set of pixels B_{c}. In this case, the current set of pixels B_{c} is predicted with respect to the reference set of pixels BR₀ using an Intra prediction, for example Intra or IBC (for “Intra Block Copy”). Of course, the current set of pixels B_{c} may be predicted with respect to the reference set of pixels BR₀ and to one or more other reference sets of pixels belonging to the current image Iᵢ.

According to the invention, as shown in FIG. 2B, the reference set of pixels BR₀ may belong to an already coded and decoded reference image that precedes or follows the current image Iᵢ in time. In this case, the current set of pixels B_{c} is predicted with respect to the reference set of pixels BR₀ using an Inter prediction. In the example shown, the current set of pixels B_{c} may be predicted with respect to the reference set of pixels BR₀ using a type P unidirectional inter prediction, the reference set of pixels BR₀ belonging for example to the immediately preceding image IRᵢ₋₁ but of course being able to belong to another reference image, such as for example the image IRᵢ₋₂ or other reference images preceding the image IRᵢ₋₂ in the coding order. Of course, one or more other reference sets of pixels may be used together with the reference set of pixels BR₀ to predict the current set of pixels B_{c}. In the example shown, the current set of pixels B_{c} may also be predicted using a type B bidirectional inter prediction, with respect to the reference set of pixels BR₀ located in a reference image that precedes the current image Iᵢ and with respect to at least one other reference set of pixels BR₁ located in a reference image that follows the current image Iᵢ. In the example shown, the reference set of pixels BR₀ is located in the reference image IRᵢ₋₂ and the reference set of pixels BR₁ is located in the reference image IRᵢ₊₁. Still within the context of such a type B inter prediction, and as shown in FIG. 2B, the current set of pixels B_{c} may be predicted with respect to two reference sets of pixels BR₀, BR₁ each located in a reference image that precedes the current image Iᵢ. In the example shown, the reference set of pixels BR₀ is located in the reference image IRᵢ₋₂ and the reference set of pixels BR₁ is located in the reference image IRᵢ₋₁.

Of course, one or more other reference sets of pixels may be used together with the reference sets of pixels BR₀ and BR₁ to compute the current prediction set of pixels BP_{c}.

In the embodiments presented below, it is assumed that the one or more reference sets of pixels BR₀, BR₁, etc. have the same geometry as the current set of pixels B_{c} to be predicted. Of course, it is also possible, depending on the context of the prediction, to oversize this reference set of pixels so as to cover an area greater than or equal to that of the current set of pixels B_{c} to be predicted.

With reference again to FIG. 1, such a prediction method according to the invention comprises the following:

In P1, said at least one reference set of pixels BR₀ is analyzed.

Such analysis implements a motion estimation comprising an estimation of the pixel shift between said at least one reference set of pixels BR₀ that was displaced beforehand and a predicted version BP_{c} of a current set of pixels B_{c} that is not available at the time of the prediction. This motion estimation implements conventional motion compensation, at the end of which a motion-compensated set of pixels BRC₀ is obtained. During this analysis, displacement information is obtained, such as a displacement vector V₀ that describes the displacement of BR₀ toward BRC₀.

In P2, a weighting value w₀ is computed for each pixel of the motion-compensated set of pixels BRC₀, depending on the result of the analysis performed in P1.

In P3, a predicted version BP_{c} of a current set of pixels B_{c} is computed according to the following function, for each coordinate (x,y) of a pixel under consideration of the motion-compensated reference set of pixels BRC₀:

BP_{c}(x,y)=w₀(x,y)*BRC₀(x,y)

When two reference sets of pixels BR₀ and BR₁ are considered during the analysis P1, thereby generating two motion-compensated sets of pixels BRC₀ and BRC₁ and the corresponding displacement vectors V₀, V₁, two weighting values w₀, w₁ are computed in P2 for the motion-compensated set of pixels BRC₀ and the motion-compensated set of pixels BRC₁, respectively. The current prediction set of pixels BP_{c} is then computed in P3 according to the following function, for each coordinate (x,y) of a pixel under consideration of the motion-compensated sets of pixels:

BP_{c}(x,y)=w₀(x,y)*BRC₀(x,y)+w₁(x,y)*BRC₁(x,y)

The prediction method that has just been described above may then be implemented for each current set of pixels to be predicted, considered to be unavailable at the time of the prediction.

### Exemplary Implementations of Weighted Prediction Device

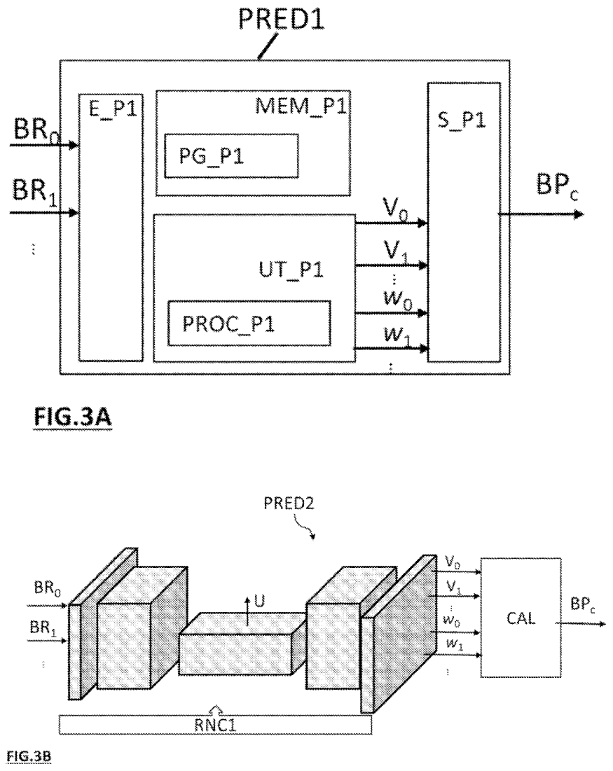

FIG. 3A shows a prediction device PRED1 suitable for implementing the prediction method illustrated in FIG. 1, according to a first embodiment of the invention. According to this first embodiment, the actions performed by the prediction method are implemented by computer program instructions. To that end, the prediction device PRED1 has the conventional architecture of a computer and comprises in particular a memory MEM_P1, a processing unit UT_P1, equipped for example with a processor PROC_P1, and driven by the computer program PG_P1 stored in memory MEM_P1. The computer program PG_P1 comprises instructions for implementing the actions of the prediction method as described above when the program is executed by the processor PROC_P1.

On initialization, the code instructions of the computer program PG_P1 are for example loaded into a RAM memory (not shown) before being executed by the processor PROC_P1. The processor PROC_P1 of the processing unit UT_P1 implements in particular the actions of the prediction method described above, according to the instructions of the computer program PG_P1.

The prediction device receives, at input E_P1, one or more reference sets of pixels BR₀, BR₁, etc., computes the one and/or more corresponding displacement vectors V₀, V₁, etc. along with the one and/or more corresponding weighting values w₀, w₁, etc., and delivers, at output S_P1, the abovementioned prediction set of pixels BP_{c}. FIG. 3B shows a prediction device PRED2 suitable for implementing the prediction method illustrated in FIG. 1, according to a second embodiment of the invention. According to this second embodiment, the prediction device PRED2 is a neural network, such as for example a convolutional neural network, a multilayer perceptron, an LSTM (for “Long Short Term Memory”), etc., denoted RNC1, which, from one or more reference sets of pixels BR₀, BR₁, etc. received at input, jointly implements steps P1 to P2 of the weighted prediction method of FIG. 1 in order to deliver, at output:
one or more respective motion vectors V₀, V₁, etc.,
one or more respective weighting values w₀, w₁, etc.

A computer CAL receives this information at input in order to compute the prediction set of pixels BP_{c} according to the abovementioned relationship:

BP_{c}(x,y)=w₀(x,y)*BRC₀(x,y)+w₁(x,y)*BRC₁(x,y).

In a manner known per se, the convolutional neural network RNC1 carries out a succession of layers of filtering, non-linearity and scaling operations. Each filter that is used is parameterized by a convolution kernel, and non-linearities are parameterized (ReLU, leaky ReLU, GDN (“generalized divisive normalization”), etc.). The neural network RNC1 is for example of the type described in the document D. Sun, et al., “PWC-Net: CNNs for Optical Flow Using Pyramid, Warping, and Cost Volume” CVPR 2018.

In this case, the neural network RNC1 may be trained:
to estimate V₀, V₁, etc. in order to interpolate motion from BR₀, BR₁, etc. to the current image currently being coded in order to make a prediction;
to estimate the weighting values w₀, w₁, etc.

To this end, in a preliminary phase, the network RNC1 is trained to carry out operation P1. For example, the network RNC1 is trained to minimize the root mean square error between an image Iᵢ to be approximated and the result BP_{c} of the weighted prediction of FIG. 1. At the end of this step, a latent space U representative of V₀, V₁, etc., w₀, w₁, etc. is obtained.

The network RNC1 is trained during a training phase by presenting a plurality of associated reference sets of pixels BR₀, BR₁, etc. together with a current set of pixels B_{c}, and by changing, for example using a gradient descent algorithm, the weights of the network so as to minimize the mean squared error between B_{c} and the result BP_{c}(x,y) computed according to the abovementioned relationship.

At the end of this preliminary training phase, the network RNC1 is fixed and suitable for use in the prediction device PRED2.

The network RNC1 is thus optimized to implement steps P1 and P2 of the weighted prediction of FIG. 1.

### Embodiment of a Weighted Prediction Method Implemented by the Prediction Device PRED1

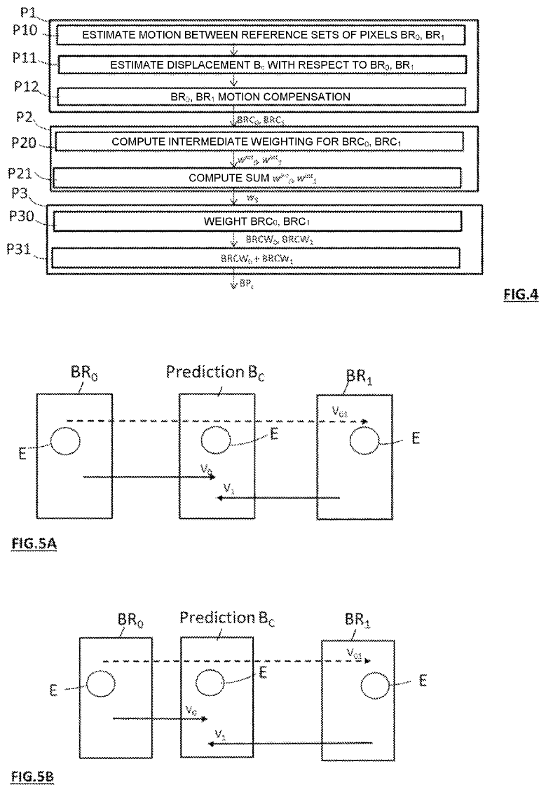

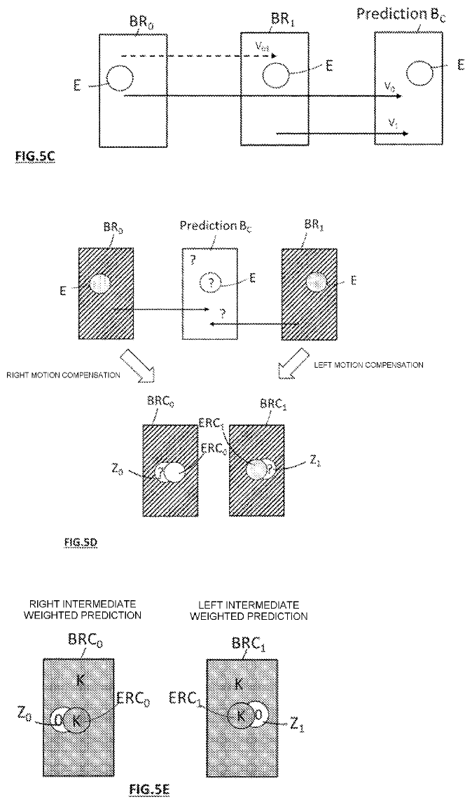

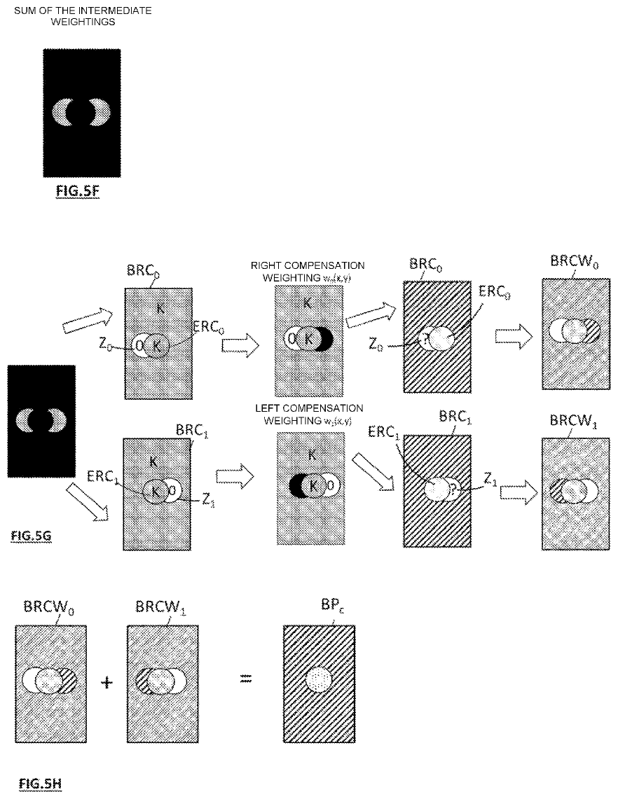

A description will now be given, with reference to FIG. 4 and FIGS. 5A to 5H, of one embodiment in which a prediction weighting for a current set of pixels is implemented in the prediction device PRED1 of FIG. 3A.

In the example shown, two reference sets of pixels BR₀ and BR₁ are taken into account for the prediction.

To this end, as illustrated in FIG. 4, the analysis P1 of at least one reference set of pixels comprises the following:

In P10, a motion estimate between BR₀ and BR₁ is computed. Such a step is performed through conventional motion search steps, such as for example an estimation of displacement vectors.

FIGS. 5A to 5C respectively show three different exemplary displacements of a predicted version BP_{c} of the current set of pixels B_{c} with respect to two reference sets of pixels BR₀ and BR₁, which may be encountered during this step P10. In the example of FIGS. 5A to 5C, the displacement of an element E (symbolized by a circle) between the reference sets of pixels BR₀ and BR₁ is represented by a field of motion vectors. For the sake of simplification, a single vector, denoted V₀₁ and shown in dotted lines in FIGS. 5A to 5C, is shown in order to describe, in the example shown, the motion of the element E from BR₀ to BR₁ (the motion on the other portions of the image being considered to be zero). However, it goes without saying that there are as many motion vectors as there are pixels representing the reference sets of pixels BR₀ to BR₁, as for example in the case of an optical flow motion estimation. According to another example not shown in FIGS. 5A to 5C, a vector V₁₀, describing the (opposite) motion from BR₁ to BR₀, could be computed.

With the vector V₀₁ or V₁₀ having been obtained in P10, P11 (FIG. 4) comprises estimating the displacement of the current set of pixels B_{c} to be predicted with respect to BR₀ and BR₁. This estimation is illustrated in FIGS. 5A to 5C, where the displacement of the element E is estimated at a time instant other than that at which BR₀ and BR₁ are located, which is the instant at which the current set of pixels B_{c} is located. Using the same conventions as for the computing of V₀₁ or V₁₀:
a single vector V₀, which describes the motion from BR₀ to the predicted position of B_{c}, is computed from the vector V₀₁,
a single vector V₁, which describes the motion from BR₁ to the predicted position of B_{c}, is computed from the vector V₀₁.

In the example of FIG. 5A, in which the current set of pixels B_{c} is located halfway in time between BR₀ and BR₁, then the displacement of the element E at the current instant is estimated as corresponding to half the displacement between BR₀ and BR₁, that is to say half the vector V₀₁ or V₁₀. Such a displacement configuration is encountered in the case where for example, adopting the same notations as in FIG. 2B, BR₀ belongs to the reference image IRᵢ₋₁ and BR₁ belongs to the reference image IRᵢ₊₁.

In the example of FIG. 5B, in which the current set of pixels B_{c} is located closer in time to BR₀ than to BR₁, then the displacement of the element E at the current instant is estimated as being shorter than half the displacement between BR₀ and BR₁. For example, if BR₀ belongs to the reference image IRᵢ₋₁ and BR₁ belongs to the reference image IRᵢ₊₂, then the displacement of the element E at the current instant is estimated as corresponding to one third of the displacement between BR₀ and BR₁, that is to say one third of the vector V₀₁ or V₁₀.

In the example of FIG. 5C, in which the current set of pixels B_{c} is located after BR₀ and then BR₁ in time, BR₀ belonging to the reference image IRᵢ₋₂ and BR₁ belonging to the reference image IRᵢ₋₂, then the displacement of the element E at the current instant is estimated as twice the displacement between BR₀ and BR₁, that is to say twice the vector V₀₁ or V₁₀.

With reference to FIGS. 4 and 5D, in P12, BR₀ and BR₁ are each motion-compensated using the vectors V₀ and V₁, in order to respectively create two predicted versions of B_{c}, denoted BRC₀ and BRC₁.

By way of illustration in FIG. 5D, it is considered that the vectors V₀ and V₁ were obtained for example in accordance with the motion configuration shown in FIG. 5A, for which the displacement of the element E at the current instant is estimated as corresponding to half the displacement between BR₀ and BR₁, that is to say half the vector V₀₁ or V₁₀.

FIG. 5D shows:
a right-motion-compensated set of pixels BRC₀, on which the interpolated position of the element E comprises a set of pixels ERC₀ resulting from the motion compensation of the element E of BR₀, by the vector V₀,
a left-motion-compensated set of pixels BRC₁, on which the interpolated position of the element E comprises a set of pixels ERC₁ resulting from the motion compensation of the element E of BR₁, by the vector V₁.

In contrast, a part Z₀ of ERC₀ and a part Z₁ of ERC₁ are undefined since they correspond to the unknown content that is located behind the element E of BR₀ and the element E of BR₁. However, as may be seen in FIG. 5D, the part Z₀ is defined in ERC₁ and the part Z₁ is defined in ERC₀.

The computing P2 of prediction weighting values w₀ and w₁ then comprises the following:

With reference to FIGS. 4 and 5E, to achieve an efficient combination of the motion-compensated reference sets of pixels BRC₀ and BRC₁, in accordance with the invention, P20 comprises computing, pixel by pixel, intermediate weightings w^{int}₀(x,y) and w^{int}₁(x,y) for the two predicted versions BRC₀ and BRC₁, respectively. Such computing makes it possible to isolate the parts of BR₀ and BR₁ that are not defined respectively in BRC₀ and BRC₁.

To this end, as illustrated in FIG. 5E, it is proposed:
to assign to zero the weighting value for each pixel of the parts Z₀ and Z₁, respectively, that is to say w^{int}₀(x,y)=0 and w^{int}₁(x,y)=0, the parts Z₀ and Z₁ being illustrated in white,
to assign to a constant K the weighting value for each defined pixel of the motion-compensated reference sets of pixels BRC₀ and BRC₁, that is to say w^{int}₀(x,y)=K and w^{int}₁(x,y)=K with for example K=0.5, corresponding to the gray color in FIG. 5E.

At the end of this operation, what is obtained is an intermediate weighting in which, for each of the motion-compensated reference sets of pixels BRC₀ and BRC₁, the white content corresponds to w^{int}₀(x,y)=0 and w^{int}₁(x,y)=0 and the gray content corresponds to w^{int}₀(x,y)=0.5 and w^{int}₁(x,y)=0.5.

With reference to FIG. 4, P21 comprises computing the sum wₛ(x,y) of the intermediate weightings w^{int}₀(x,y) and w^{int}₁(x,y),

where wₛ(x,y)=w₀^{int}(x,y)+w₁^{int}(x,y)

The computing of the sum of the intermediate weightings w^{int}₀(x,y) and w^{int}₁(x,y) is illustrated in FIG. 5F, in which the black content corresponds to wₛ(x,y)=1 and the gray content corresponds to wₛ(x,y)=0.5.

The computing P3 of the prediction weighting function then comprises the following:

With reference to FIG. 4, during the operation P30, the motion-compensated predicted versions BRC₀ and BRC₁ are weighted by their respective weightings w₀ and w₁. Weighted compensated predicted versions BRC₀ and BRC₁ are then obtained.

To this end, the following compensation weightings w₀(x,y) and w₁(x,y) are computed for each motion-compensated reference set of pixels BRC₀ and BRC₁, respectively:

w₀(x,y)=w₀^{int}(x,y)/wₛ(x,y)

and

w₁(x,y)=w₁^{int}(x,y)/wₛ(x,y)

Such compensation weighting is shown in FIG. 5G. The white content corresponds to the undefined regions Z₀ and Z₁ for which w₀(x,y)=0 and w₁(x,y)=0. The black content corresponds to the perfectly defined regions for which w₀(x,y)=1 and w₁(x,y)=1. The gray content corresponds to the background and to the element E, for which w₀(x,y)=0.5 and w₁(x,y)=0.5.

The predicted versions BRC₀ and BRC₁ are then motion-compensated and weighted by their respective weightings w₀ and w₁. Weighted compensated predicted versions BRCW₀ and BRCW₁ are then obtained.

With reference to FIGS. 4 and 5H, during the operation P31, the weighted compensated predicted versions BRCW₀ and BRCW₁ are summed, providing a motion-compensated prediction set of pixels BP_{c}.

This has thus constructed motion compensation including a compensation weighting determined by elements present only at the time of the prediction, that is to say only on the reference sets of pixels BR₀ and BR₁. One particular advantage of such a compensation weighting compared to the currently standardized solutions lies in the fact that, with BR₀ and BR₁ being perfectly known at the time of the prediction and the prediction according to the invention using only BR₀ and BR₁, it is possible to effectively deal with disocclusions during the prediction, as illustrated in FIGS. 5D to 5H, where the abovementioned occluded regions Z₀ and Z₁ may be restored with very good spatial precision.

The prediction weighting may be presented in another form. For example, a single weighting w may be used. Then, w weights the motion-compensated reference set of pixels BRC₀ and (1−w) weights the motion-compensated reference set of pixels BRC₁.

w may be computed based on the above embodiment starting from the weighting values w₀ and w₁ computed beforehand, and by performing:

$$w ( x , y ) = \frac{{w}_{0} ( x , y ) + 1 - {w}_{1} ( x , y )}{2}$$

Although a prediction method has been described above, such a method could also be implemented to construct or synthesize a set of pixels B_{c} from one or more reference sets of pixels BR₀, BR₁, etc. using the weighted prediction function that has just been described. The prediction method could be called a construction or synthesis method for the set of pixels B_{c}, corresponding for example to a missing set of pixels or a set of pixels not captured by a camera (360° video). In this case, strictly speaking, the prediction devices PRED1 and PRED2 will be considered more to be construction or synthesis devices. The prediction device PRED1 could thus implement a so-called view “synthesis” algorithm. For example, the VSRS (for “View Synthesis Reference”) software, the VVS (“Versatile View Synthesizer”) algorithm, may be used as view synthesis algorithm. The construction or synthesis device PRED2 may for its part, as described above, be a neural network, such as for example a convolutional neural network, a multilayer perceptron, an LSTM (for “Long Short Term Memory”), etc.

### Image Coding Method

### General Principle

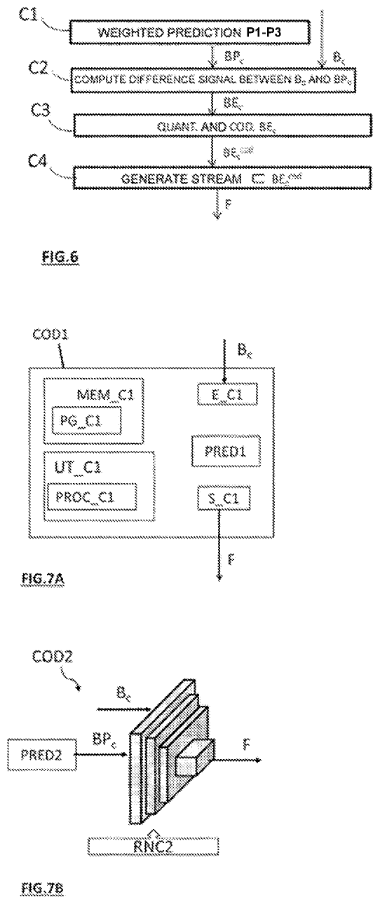

A description is given below, with reference to FIG. 6, of an image coding method implementing the weighted prediction described with reference to FIG. 1.

Such a coding method comprises the following:

In C1, the weighted prediction, in its steps P1 to P3 illustrated in FIG. 1, is implemented, generating the current prediction set of pixels BP_{c}.

The following coding steps are conventional and compliant with AVC, HEVC, VVC coding or the like. Thus:
in C2, a signal BE_{c} representative of the difference between the current set of pixels B_{c} and the current prediction set of pixels BP_{c} obtained in C1 is computed;
in C3, in the case where this signal BE_{c} is the one that optimizes the coding with respect to a conventional coding performance criterion, such as for example minimizing the distortion/data rate cost or else the choice of the best efficiency/complexity compromise, which are criteria that are well known to those skilled in the art, the signal BE_{c} is quantized and coded.

At the end of this operation, a quantized and coded difference signal BE_{c}^{cod} is obtained.

During the coding C3, multiple coding possibilities may be explored, for example a plurality of prediction weighting values w₀, w₁, etc. may be investigated to find the best data rate/distortion or efficiency/complexity compromise.

The encoder may put the weighting values computed according to the prediction method described above in competition with weighting values that it may choose to transmit. To this end, it may evaluate the quality of the prediction BPc obtained from the above prediction method and measure the prediction error, for example using a root mean squared error. This prediction error may be compared with the prediction error resulting from a set of pairs of predetermined weighting values (w₀,w₁) as used in current video standards. This set may be restricted to (0.5,0.5), as for example in the HEVC (for “High Efficiency Video Coding”) standard or comprise other values, such as for example those used in the BCW (for “Bi-prediction with CU level Weights”) tool of the VVC (for “Versatile Video Coding”) standard. A flag will indicate to the decoder whether it should use the prediction method described above or whether it should apply the VVC BCW tool or whether it should apply the HEVC balanced prediction.

This putting of the prediction weighting values w₀, w₁, etc. into competition has the advantage of optimizing the precision of the weighted prediction in comparison with the default prediction weighting implemented in the prediction devices from the prior art. Indeed, the prediction weighting of the invention generates more precise weighting values, but may lead to greater distortion when the signal is not predictable. A conventional prediction weighting, although it is less spatially precise and at the expense of a data rate to be transmitted, may lead to lower distortion.

In C4, the data of the quantized and coded difference signal BE_{c}^{cod} are written to a transport stream F able to be transmitted to a decoder, which will be described later in the description.

By contrast, in accordance with the invention, the weighting w₀ and/or the weighting w₁ are advantageously neither coded nor transmitted to the decoder.

Of course, in the case where the quantized and coded difference signal BE_{c} is zero, which may be the case for the SKIP coding mode, the abovementioned steps C2 and C4 are not implemented.

### Encoder Exemplary Implementations

FIG. 7A shows an encoder COD1 suitable for implementing the coding method illustrated in FIG. 6, according to a first embodiment of the invention. The encoder COD1 comprises the prediction device PRED1.

According to this first embodiment, the actions performed by the coding method are implemented by computer program instructions. To that end, the coding device COD1 has the conventional architecture of a computer and comprises in particular a memory MEM_C1, a processing unit UT_C1, equipped for example with a processor PROC_C1, and driven by the computer program PG_C1 stored in memory MEM_C1. The computer program PG_C1 comprises instructions for implementing the actions of the coding method as described above when the program is executed by the processor PROC_C1.

On initialization, the code instructions of the computer program PG_C1 are for example loaded into a RAM memory (not shown) before being executed by the processor PROC_C1. The processor PROC_C1 of the processing unit UT_C1 implements in particular the actions of the coding method described above, according to the instructions of the computer program PG_C1.

The encoder COD1 receives, at input E_C1, a current set of pixels B_{c} and delivers, at output S_C1, the transport stream F, which is transmitted to a decoder using a suitable communication interface (not shown).

FIG. 7B shows an encoder COD2 suitable for implementing the coding method illustrated in FIG. 6, according to a second embodiment of the invention. The encoder COD2 comprises the abovementioned prediction device PRED2 followed by a convolutional neural network RNC2 that for example computes and then codes the difference signal BE_{c} or codes the current set of pixels B_{c} together with the prediction set of pixels BP_{c} generated by the prediction device PRED2. Such a network RNC2 is for example of the type described in the document: Ladune “Optical Flow and Mode Selection for Learning-based Video Coding”, IEEE MMSP 2020.

### Image Decoding Method

### General Principle

A description is given below, with reference to FIG. 8, of an image decoding method implementing the weighted prediction described with reference to FIG. 1.

Such a decoding method implements image decoding corresponding to the image coding of FIG. 6. In particular, apart from the weighted prediction, the decoding method implements conventional decoding steps that are compliant with AVC, HEVC, VVC decoding or the like.

The decoding method comprises the following:

In D1, data of the coded difference signal BE_{c}^{cod} are extracted, in a conventional manner, from the received transport stream F.

In D2, BE_{c}^{cod} is decoded in a conventional manner. At the end of this operation, a decoded difference signal BE_{c}^{dec} is obtained.

In D3, the weighted prediction according to the invention, in its steps P1 to P3 illustrated in FIG. 1, is implemented, generating the current prediction set of pixels BP_{c}.

In D4, a reconstructed current set of pixels BD_{c} is computed by combining the decoded difference signal BE_{c}^{dec} obtained in D2 with the prediction set of pixels BP_{c} obtained in D3.

In a manner known per se, the reconstructed current set of pixels BD_{c} may possibly undergo filtering by a loop filter performed on the reconstructed signal, which is well known to those skilled in the art.

Of course, in the case where the difference signal BE_{c} that was computed during the abovementioned coding method is zero, which may be the case for the SKIP coding mode, the abovementioned steps D1 and D2 are not implemented.

### Decoder Exemplary Implementations

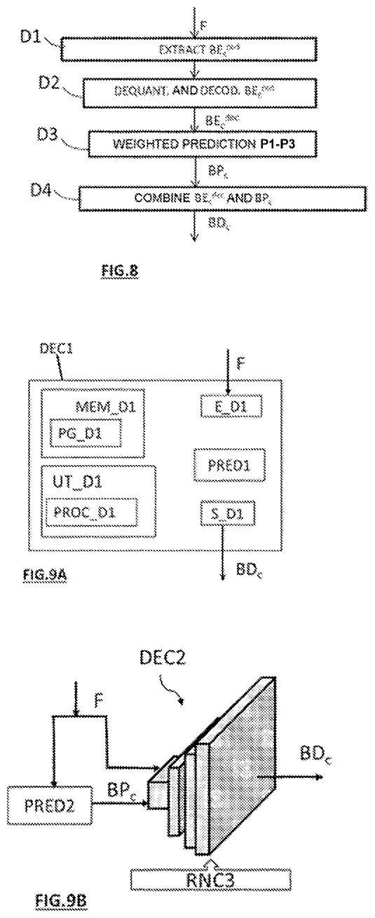

FIG. 9A shows a decoder DEC1 suitable for implementing the decoding method illustrated in FIG. 8, according to a first embodiment of the invention. The decoder DEC1 comprises the prediction device PRED1.

According to this first embodiment, the actions performed by the decoding method are implemented by computer program instructions. To that end, the decoder DEC1 has the conventional architecture of a computer and comprises in particular a memory MEM_D1, a processing unit UT_D1, equipped for example with a processor PROC_D1, and driven by the computer program PG_D1 stored in memory MEM_D1. The computer program PG_D1 comprises instructions for implementing the actions of the decoding method as described above when the program is executed by the processor PROC_D1.

On initialization, the code instructions of the computer program PG_D1 are for example loaded into a RAM memory (not shown) before being executed by the processor PROC_D1. The processor PROC_D1 of the processing unit UT_D1 implements in particular the actions of the decoding method described above in connection with FIG. 8, according to the instructions of the computer program PG_D1.

The decoder DEC1 receives, at input E_D1, the transport stream F transmitted by the encoder COD1 of FIG. 7A and delivers, at output S_D1, the current decoded set of pixels BD_{c}.

FIG. 9B shows a decoder DEC2 suitable for implementing the decoding method illustrated in FIG. 8, according to a second embodiment of the invention. The decoder DEC2 comprises the abovementioned prediction device PRED2 followed by a convolutional neural network RNC3 that for example decodes the coded difference signal BE_{c}^{cod} or decodes the coded difference signal BE_{c}^{cod} together with the prediction set of pixels BP_{c} generated by the prediction device PRED2. Such a network RNC3 is for example of the type described in the document: Ladune “Optical Flow and Mode Selection for Learning-based Video Coding”, IEEE MMSP 2020.

### Variant of the Image Weighted Prediction Method

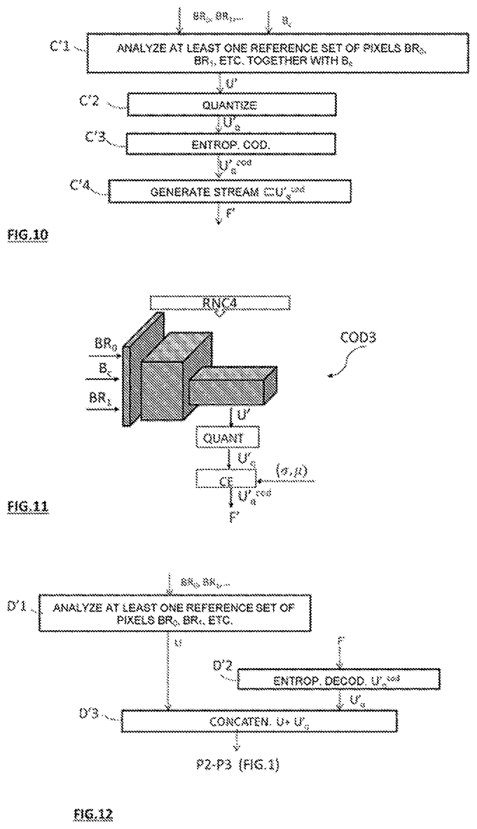

A description will now be given, with reference to FIGS. 10 and 11, of one variant of the weighted prediction method illustrated in FIG. 1, as implemented in an encoder COD3.

Such a variant aims to improve the weighted prediction method of FIG. 1 when the precision/quality of the prediction that is obtained is not satisfactory.

To this end, on the encoder side, as illustrated in FIG. 10, in C′1, said at least one reference set of pixels BR₀ is analyzed together with the current set of pixels B_{c}. For example, two reference sets of pixels BR₀ and BR₁ are analyzed together with B_{c}. In the example shown, BR₀ is located before B_{c} in time and BR₁ is located after B_{c} in time.

As shown in FIG. 11, the analysis C′1 is implemented using a convolutional neural network RNC4 that creates, from the two reference sets of pixels BR₀ and BR₁ and from the current set of pixels B_{c}, a transformation through a certain number of layers, such as for example layers implementing convolutional filters (CNN) followed by layers implementing non-linearities and decimations, as described in the document: Ladune “Optical Flow and Mode Selection for Learning-based Video Coding”, IEEE MMSP 2020.

At the end of step C′1, a set of latent variables is obtained in the form of a signal U′. The signal U′ is quantized in C′2 by a quantizer QUANT, for example a uniform or vector quantizer controlled by a quantization parameter. A quantized signal U′_{q} is then obtained.

At C′3, the quantized signal U′_{q} is coded using an entropy encoder CE, for example of arithmetic type, with a determined statistic. This statistic is for example parameterized by probabilities of statistics, for example by modeling the variance and the mean of a Laplacian law (σ,μ), or else by considering hyperpriors as in the publication: “Variational image compression with a scale hyperprior by Ballé, which was presented at the ICLR 2018 conference. A coded quantized signal U′_{q}^{cod} is then obtained.

In C′4, the coded quantized signal U′_{q}^{cod} is written to a transport stream F′, which is transmitted to a decoder DEC3, illustrated in FIG. 13.

A description will now be given, with reference to FIGS. 12 and 13, of one variant of the weighted prediction method illustrated in FIG. 1, as implemented in a decoder DEC3.

To this end, on the decoder side, as illustrated in FIG. 12, in D′1, at least one reference set of pixels BR₀ is analyzed, two sets of reference pixels BR₀ and BR₁ in the example shown. Such analysis is identical to that performed in step P1 of FIG. 1, using the neural network RNC1. At the end of this step, a latent space U representative of V₀, V₁, etc., w₀, w₁, etc. is obtained.

Following the reception of the stream F′, in D′2, entropy decoding is carried out on the coded quantized signal U′_{q}^{cod} using an entropy decoder DE corresponding to the entropy encoder CE of FIG. 11, with the same determined statistic, such as the modeling of the variance and of the mean of a Laplacian law (σ,μ). A decoded quantized signal U′_{q} is obtained at the end of this operation.

In D′3, the decoded quantized signal U′_{q} is concatenated with the latent space U obtained by the neural network RNC1 of FIG. 13 and representative of the analysis of only the reference sets of pixels BR₀ and BR₁.

The neural network RNC1 then processes this concatenation through various layers, in the same way as in step P2 of FIG. 1, in order to estimate the motion information V₀, V₁, etc., along with the corresponding weighting values w₀, w₁, etc.

In a manner corresponding to FIG. 3B, a computer CAL receives this information at input in order to compute the prediction set of pixels BP_{c} according to the abovementioned relationship. This step is identical to step P3 of FIG. 1.

In the embodiments that have been disclosed above with reference to FIG. 3A et seq., two reference sets of pixels BR₀, BR₁ are used in the weighted prediction method.

These embodiments may be extended to three or more reference sets of pixels. To this end, the neural network RNC1 described with reference to FIG. 3B will be trained from three reference sets of pixels BR₀, BR₁, BR₂ or more to obtain the prediction set of pixels BP_{c}(x,y).

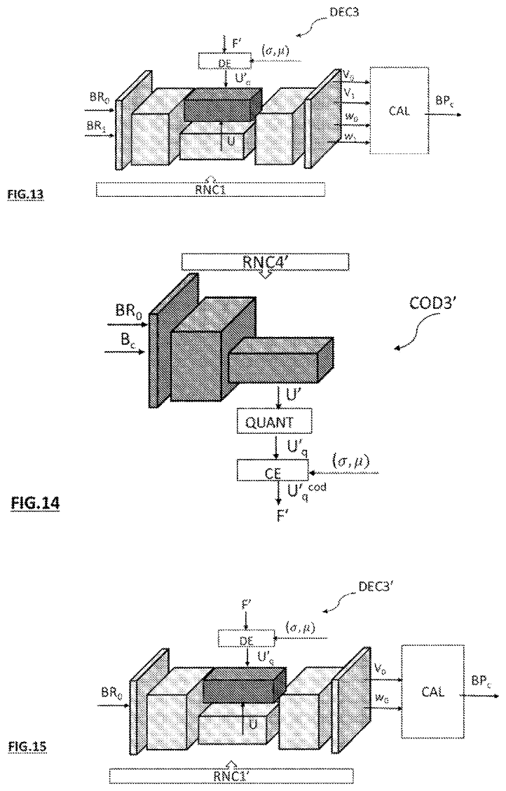

A degraded weighted prediction mode is of course possible, for example when only one reference frame is used for the prediction (case of type P prediction in video coding mode). Such a degraded mode is illustrated with reference to FIGS. 14 and 15. The example of FIG. 14 shows an encoder COD3′ that is similar to the encoder COD3 of FIG. 11. The encoder COD3′ differs from the encoder COD3 through its neural network RNC4′, which is trained from a single reference set of pixels, BR₀ in FIG. 14. The neural network RNC4′ thus generates a signal U′ from the single reference set of pixels BR₀ and from the current set of pixels B_{c}. As already described above in connection with FIGS. 10 and 11, the signal U′ is quantized in order to obtain a quantized signal U′_{q}. The quantized signal U′_{q} is entropically coded. A coded quantized signal U′_{q}^{cod} is then obtained. The coded quantized signal U′_{q}^{cod} is written to a transport stream F′, which is transmitted to a decoder DEC3′, illustrated in FIG. 15.

The decoder DEC3′ differs from the decoder DEC3 of FIG. 13 through its neural network RNC1′, which analyzes a single reference set of pixels, BR₀ in the example shown. At the end of this analysis, a latent space U representative of V₀ and w₀ is obtained. As already explained above with reference to FIG. 12, following the reception of the stream F′, the coded quantized signal U′_{q}^{cod} is entropically decoded, generating a decoded quantized signal U′_{q}. The decoded quantized signal U′_{q} is concatenated with the latent space U obtained by the neural network RNC1′. The neural network RNC1′ then processes this concatenation in order to estimate the single item of motion information V₀ along with the single corresponding weighting value w₀. The computer CAL receives this information at input in order to compute, in a conventional manner, the prediction set of pixels BP_{c} according to the abovementioned relationship with BRC₁=0, since BR₁ was not considered, and therefore not motion-compensated. Likewise, w₁(x,y)=0.

This means that the prediction set of pixels BP_{c} obtained at the end of step P3 of FIG. 1 and delivered at output of the computer CAL is:

BP_{c}(x,y)=w₀(x,y)*BRC₀(x,y)+0*0=w₀(x,y)*BRC₀(x,y).

1. A method implemented by a prediction device, the method comprising:
receiving at least one reference set of pixels belonging to an already decoded reference image;
predicting at least one current set of pixels based on the at least one reference set of pixels and using a pixel prediction weighting function, wherein said pixel prediction weighting function for said at least one current set of pixels comprises at least one weighting value computed based on an analysis of the at least one reference set of pixels; and
outputting the at least one current set of pixels.

2. The prediction method as claimed in claim 1, wherein the analysis of at least one reference set of pixels implements motion estimation or filtering of said at least one reference set of pixels.

3. The prediction method as claimed in claim 2, wherein the motion estimation is optical flow motion estimation.

4. The prediction method as claimed in claim 1, wherein the prediction weighting function is modified using at least one modification parameter that results from joint analysis of said at least one current set of pixels and of at least one reference set of pixels.

5. A device for predicting at least one current set of pixels, comprising:
at least one processor; and
at least one processor-readable medium comprising instructions stored there on which when executed by the at least one processor configures the at least one processor to predict said at least one current set of pixels based on at least one reference set of pixels belonging to an already decoded reference image, using a pixel prediction weighting function, wherein said pixel prediction weighting function for said at least one current set of pixels comprises at least one weighting value computed based on an analysis of the at least one reference set of pixels.

6. The prediction device as claimed in claim 5, wherein instructions configure the at least one processor to executes a neural network.

7. (canceled)

8. A non-transitory computer-readable information medium comprising instructions of a computer program stored thereon which when executed by at least one processor of a prediction device configure the prediction device to execute a method comprising:
predicting at least one current set of pixels based on at least one reference set of pixels belonging to an already decoded reference image, using a pixel prediction weighting function, wherein said pixel prediction weighting function for said at least one current set of pixels comprises at least one weighting value computed based on an analysis of at least one reference set of pixels.

9. A method implemented by a coding device, comprising:
receiving at least one current set of pixels;
coding the at least one current set of pixels by:
computing a signal representative of a difference between said at least one current set of pixels and a prediction set of pixels resulting from a prediction of said at least one current set of pixels based on at least one reference set of pixels belonging to an already decoded reference image, using a pixel prediction weighting function, wherein said pixel prediction weighting function for said at least one current set of pixels comprises at least one weighting value computed based on an analysis of the at least one reference set of pixels,
coding said signal,
outputting the signal.

10. The coding method as claimed in claim 9, comprising:
coding at least one modification parameter of the prediction weighting function,
transmitting said at least one coded modification parameter to an image decoder.

11. A device comprising:
at least one a processor; and
at least one processor-readable medium comprising instructions stored there on which when executed by the at least one processor configures the at least one processor to code at least one current set of pixels by:
computing a signal representative of a difference between said at least one current set of pixels and a prediction set of pixels resulting from a prediction of said at least one current set of pixels based on at least one reference set of pixels belonging to an already decoded reference image, using a pixel prediction weighting function, wherein said pixel prediction weighting function for said at least one current set of pixels comprises at least one weighting value computed based on an analysis of the at least one reference set of pixels, and
coding said signal.

12. A method for decoding at least one current set of pixels, implemented by a decoding device, comprising the following:
receiving a data signal,
determining, in the data signal, data representative of a signal representative of a difference between said at least one current set of pixels and a prediction set of pixels resulting from a prediction of said at least one current set of pixels based on at least one reference set of pixels belonging to an already decoded reference image, using a pixel prediction weighting function, wherein said pixel prediction weighting function for said at least one current set of pixels comprises at least one weighting value computed based on an analysis of the at least one reference set of pixels,
reconstructing said at least one current set of pixels from the determined data and from the prediction set of pixels.

13. The decoding method as claimed in claim 12, furthermore:
determining, in said data signal or another data signal, at least one coded parameter, said parameter being a modification parameter of the prediction weighting function,
decoding said coded modification parameter,
computing a modified prediction weighting function based on the analysis of said at least one reference set of pixels and said at least one decoded modification parameter.

14. A device comprising:
at least one processor;
at least one processor-readable medium comprising instructions stored there on which when executed by the at least one processor configures the at least one processor to decode at least one current set of pixels by:
receiving a data signal,
determining, in the data signal, data representative of a signal representative of a difference between said at least one current set of pixels and a prediction set of pixels resulting from a prediction of said at least one current set of pixels based on at least one reference set of pixels belonging to an already decoded reference image, using a pixel prediction weighting function, wherein said pixel prediction weighting function for said at least one current set of pixels comprises at least one weighting value computed based on an analysis of the at least one reference set of pixels,
reconstructing said at least one current set of pixels from the determined data and from the prediction set of pixels.

15. (canceled)

16. A non-transitory computer-readable information medium comprising instructions of a computer program stored thereon which when executed by at least one processor of s decoding device configure the decoding device to execute a method comprising:
receiving a data signal,
determining, in the data signal, data representative of a signal representative of a difference between said at least one current set of pixels and a prediction set of pixels resulting from a prediction of said at least one current set of pixels based on at least one reference set of pixels belonging to an already decoded reference image, using a pixel prediction weighting function, wherein said pixel prediction weighting function for said at least one current set of pixels comprises at least one weighting value computed based on an analysis of the at least one reference set of pixels,
reconstructing said at least one current set of pixels from the determined data and from the prediction set of pixels.
